(19) United States
(12) Patent Application Publication
(10) Pub. No.: US 2009/0151118 A1
(43) Pub. Date: Jun. 18, 2009

(54) HINGE FOR A FOLDABLE DEVICE

(76) Inventors: Tapio Karkkola, Turku (FI); Mikko Timperi, Raisio (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/959,254

(22) Filed: Dec. 18, 2007

(51) Int. Cl. E05F 1/08

(52) U.S. Cl. 16/308

(57) ABSTRACT

A hinge structure is shown for use in portable electronic devices, making it possible to turn a first housing part and a second housing part of the device in relation to an axis of rotation of a hinge structure, the hinge structure comprising a torsion spring, which has a first end and a second end and a longitudinal axis, and the first end of the spring is connected to a first hinge half and the second end of the spring is connected to a second hinge half in such a manner that the connection point of the second end of the spring is able to rotate around the axis of the spring.

### FIELD OF THE INVENTION

The present invention relates generally to hinges and more precisely to a hinge structure to be used in portable electronic devices, making it possible to turn a first housing part and a second housing part of the device in relation to an axis of rotation of the hinge structure.

### BACKGROUND OF THE INVENTION

Fold-type devices, e.g. mobile phones, typically have some kind of a mechanism that helps the cover to open or close. This mechanism is normally implemented in a hinge of the device and could include coil springs and cams.

Patent publication U.S. Pat. No. 6,952,860 discloses one hinge structure with a rotary actuator. This kind of a structure, comprising coil springs and cams is disadvantageous for a manufacturing process, because it requires many parts and many working phases.

### SUMMARY OF THE INVENTION

It is an object of the present invention to provide a new hinge mechanism of a fold-type portable electronic device that is easy to produce.

It is another object of the present invention to provide a fold-type device with a hinge mechanism, which hinge mechanism is easy to produce.

The foregoing objects are accomplished by a hinge mechanism of a fold-type portable electronic device, comprising at least a torsion spring, which has a first end and a second end and a longitudinal axis, and the first end of the spring is connected to a first hinge half and the second end of the spring is connected to a second hinge half in such a manner that the connection point of the second end of the spring is able to rotate around the axis of the spring.

In one embodiment the torsion spring is a wire spring and at least a part of the longitudinal axis of the spring is placed on the axis of rotation of the hinge structure.

In one embodiment the hinge structure has at least two positions, a first position and a second position, and the torsion spring is adjusted to reach a maximum tension when the position is changed from the first position to the second position and the tension of the spring is in a minimum in the first position and in the second position.

In one embodiment the second hinge half comprises a connection point, which is a holding slot for holding the second end of the spring and the holding slot is next to the axis of rotation of the hinge structure.

In one embodiment the hinge structure comprises a bush unit that is placed on the axis of rotation of the hinge structure.

Preferably the hinge structure assist the movement of a lid or a cover in fold-type devices. In one embodiment the spring assists the movement of a lid to the open or closed position.

Different embodiments and solutions of the hinge mechanism offer many different advantages. In one solution the parts of the hinge mechanism are easy to manufacture. In another solution the mechanism is robust. In addition, in one solution the mechanism is easy to replace, if the need arises. It is also possible to produce a reduced locking system. In addition, the disclosed mechanism could be implemented into the device with many different kinds of hinges.

### BRIEF DESCRIPTION OF THE DRAWINGS

The objects and features of the present invention will become more apparent from the consideration of the following detailed description taken in conjunction with the accompanying drawings, in which:

FIG. 1 illustrates an embodiment of a device with a hinge mechanism when the device is closed

FIG. 2 illustrates the embodiment of FIG. 1 when the device is opened

FIG. 3 illustrates an embodiment of a hinge mechanism

FIG. 4 illustrates the embodiment of FIG. 3 from a different angle of view

FIG. 5 illustrates some parts of a hinge mechanism according to an embodiment

FIG. 6 illustrates some parts of a hinge mechanism according to another embodiment

FIG. 7 illustrates positions of a hinge mechanism according to an embodiment

FIG. 8 illustrates another embodiment of a hinge mechanism when the device is closed

FIG. 9 illustrates a detail of the embodiment of FIG. 8

FIG. 10 illustrates the detail of the embodiment according to FIG. 8 from another angle of view

FIG. 11 illustrates an embodiment of a device when it is opened

FIG. 12 illustrates an embodiment of a device when it is closed

FIG. 13 illustrates another embodiment of a device when it is closed

For the sake of clarity, the figures only show the details necessary for understanding the invention. The structures and details that are not necessary for understanding the invention but are obvious for anyone skilled in the art have been omitted from the figures in order to emphasize the characteristics of the invention.

### DETAILED DESCRIPTION OF THE INVENTION

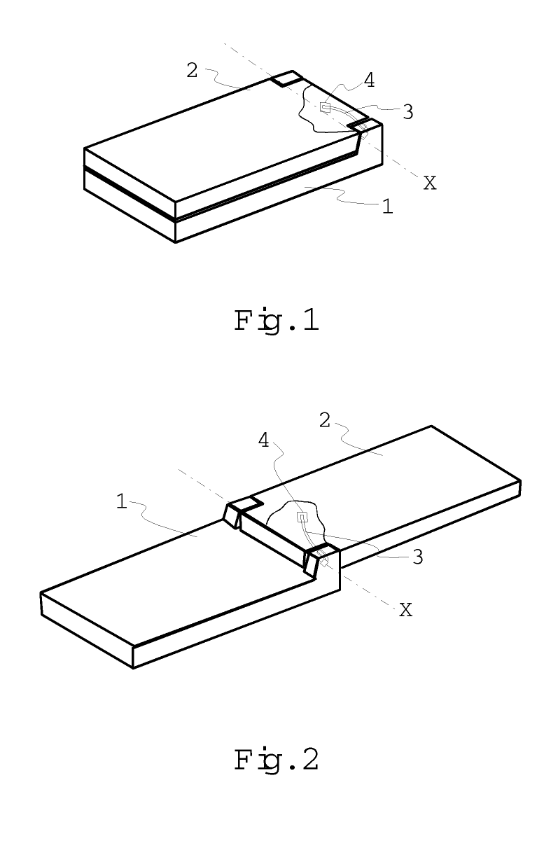

FIG. 1 illustrates a portable electronic device with a hinge mechanism in a closed position and FIG. 2 illustrates the device in an opened position. The portable electronic device can be, for example, a mobile phone, a personal computer, a hand-held computer, a hand-held media device, or a game machine.

The foldable device comprises a hinge structure making it possible to turn the first part of the body 1 (the first housing part) and the second part of the body 2 (the second housing part) of the device in relation to the axis of rotation X of the hinge structure. The hinge structure is connected by the first hinge half to the first part of the body 1 of the device and by the second hinge half to the second part of the body 2. Preferably (and in this description) the first hinge half and the first part of the body 1 of the device are integrated in the same component, as well as the second hinge half and the second part of the body 2, and therefore the same reference numbers are used for the hinge halves and the parts of the body (namely 1 and 2).

The hinge mechanism comprises at least a first hinge half 1 and a second hinge half 2, which are arranged to be movable in relation to each other by means of a pivot placed on the axis of rotation X. The means of a pivot could be, for example, a bolt, a hinge block, a hinge link, a hinge pin, a link-bolt, a link rod, a pin, a pintle or a swivel. In addition, the hinge structure comprises a torsion spring 3, which has a first end 3a and a second end 3b. The first end 3a of the spring is connected to the first hinge half 1. The second end 3b of the spring is connected to the second hinge half 2 in such a manner that the connection point 4 of the second end of the spring is able to rotate around the axis of the spring XS. FIGS. 3 and 4 illustrate the hinge mechanism from different angles of view. In these figures the device is in the closed position.

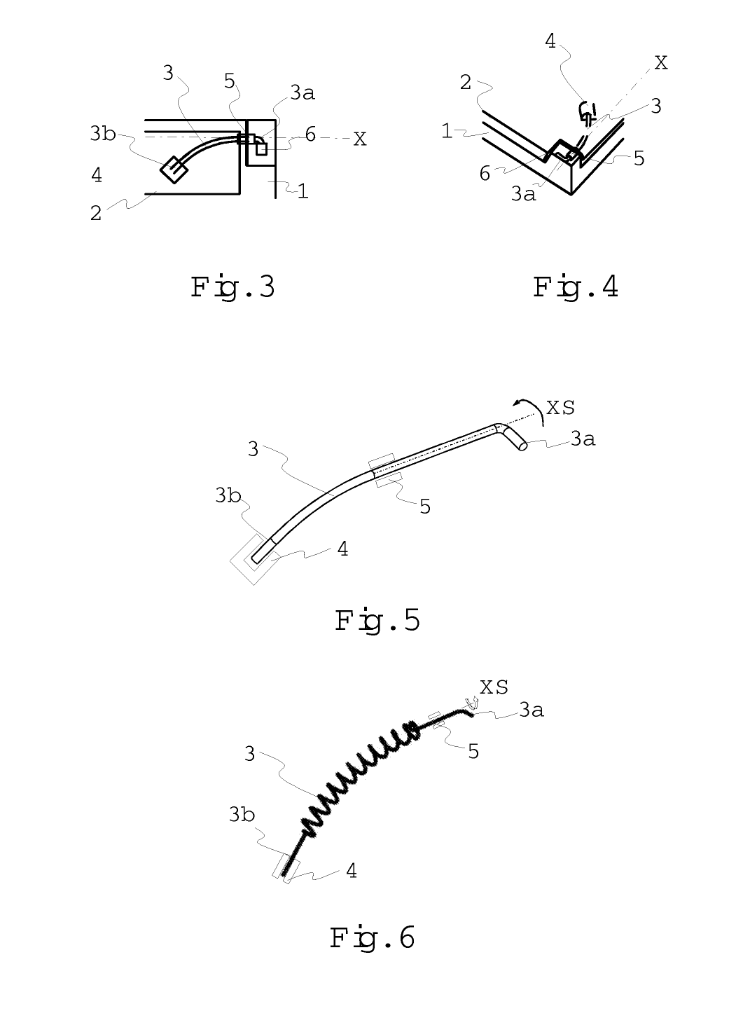

FIG. 5 illustrates a part of the hinge mechanism and more precisely the figure discloses a torsion spring 3 (a wire spring) comprising a first end 3a, a second end 3b and the axis of the spring XS. In addition, the connection point 4 and a bush unit 5 (which is described later) are shown. The torsion spring 3 is preferably a wire spring, which needs less space than a coil spring. FIG. 6 illustrates another embodiment of the torsion spring 3. In this solution the torsion spring 3 is partly spiral shaped. This kind of a shape decreases load on the deflecting region (region between the connection point 4 and the bush unit 5) of the torsion spring 3.

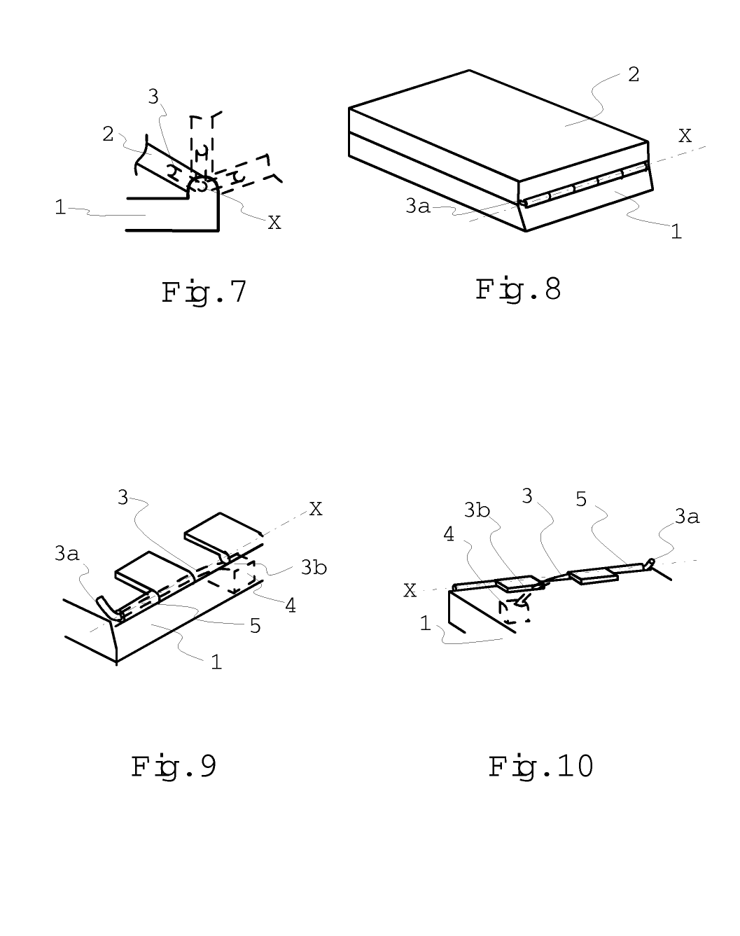

FIG. 7 illustrates the path of the second body 2 in relation to the first body 1 in one embodiment. In one embodiment the hinge structure assists the movement of the second body 2 of the device (such as a cover or a lid) to the open or closed position. Preferably this is achieved by using an L-shaped torsion spring 3, as shown in FIGS. 3 to 5. The first end (straight end) 3a of the spring is inserted into a holding slot (for example a hole or a recess) in the first body 1 of the device (the bottom part of the device) and the second end (twisted end) 3b of the spring is attached to the cover part 2 of the device. The recess 6 for the first end 3a is placed in the first body 1 so that the spring 3 is bent when it is in place. The second end 3b is attached to the second body 2 in such a way that when the device is closed, the twisted end is on the same plane as the bent part of the spring 3.

In the embodiment of FIGS. 3 and 4 the second hinge half 2 comprises a connection point 4, which is a holding slot for holding the second end 3b of the spring and the holding slot is next to the axis of rotation X of the hinge structure.

When the device is opened the second end 3b of the spring rotates in the connection point 4 so there is no rotational tension. However, turning of the second body (such as a cover or a lid) moves the second end 3b of the spring away from the same plane with the first end 3a (bent part of the spring) and introduces new tension to the spring 3. Further opening increases this tension and a maximum tension is reached when the second body 2 is opened 90 degrees. After that the tension starts to decrease as the second body 2 moves towards a second rest position, which is achieved when the second body is opened 180 degrees. In use this means that if the user of the device opens the second body 2 more than 90 degrees, the spring 3 moves the second body to a fully open position and vice versa. In a preferred embodiment the force directed to the bent part of the spring 3 is constant during the movement because the arc of the spring 3 is constant.

FIGS. 1 to 4 illustrates the profile of the spring 3 in the open position and in the closed position in one embodiment. FIG. 1 illustrates the profile when the second body 2 is closed and the profile of the spring 3 is an inward arc (when looking from the axis of rotation X). FIG. 2, in turn, illustrates the profile when the second body 2 is opened and the profile of the spring 3 is still an inward arc (when looking from the axis of rotation X).

In this embodiment a connection point 4 comprises a recess with a hole for the spring 3. The direction of the hole is advantageously congruent with the profile of the spring 3. As can be seen from FIG. 1, the direction is inclined against the axis of rotation X in such a manner that the opening of the connection point 4 is at least partly toward the axis of rotation.

In addition, this embodiment comprises a bush unit 5 that is placed on the axis of rotation of the hinge structure X. The direction of the hole of the unit 5 is the same as the axis of rotation X.

In one embodiment there is a dead center between the closed position and the opened position. When the second body 2 (such as a cover or a lid) is in the dead center, there is no such force that tries to close or open the second body 2. In one embodiment the dead center is reached when the second body 2 is opened substantially 90 degrees.

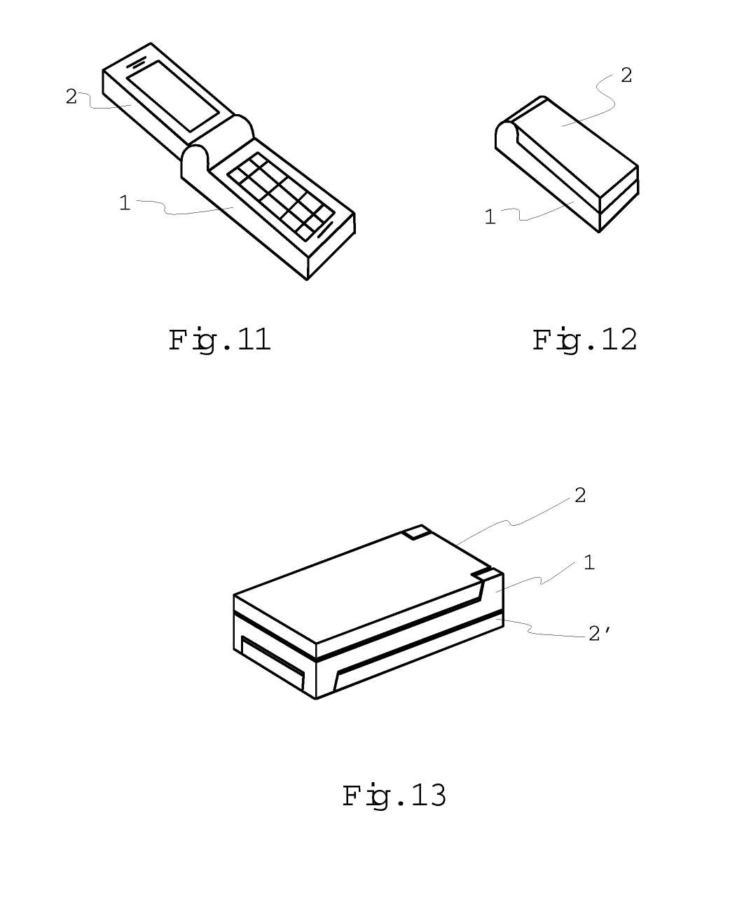

FIGS. 8 to 10 illustrate another embodiment of a portable electronic device with a hinge mechanism in a closed position. FIG. 8 shows the device and FIGS. 9 and 10 show only a part of the device from different angles of view. In this embodiment the wire spring 3 operates also as a hinge pin. The spring 3 connects the first body 1 and the second body 2 in such a manner that it is possible to turn the first part of the body and the second part of the body of the device in relation to the axis of rotation X. In this embodiment the hinge structure requires very little space.

In the foregoing embodiment the second body 2 is opened 180 degrees. It is also possible to use the hinge in devices, where the second body 2 is opened less than 180 degrees. In one embodiment the device comprises a block stop. In another embodiment the hinge comprises a block stop. The block stop limits the path of the second body 2 in relation to the first body 1.

In the foregoing embodiments there are only two body parts 1, 2 in the device as shown, for example, in FIGS. 11 and 12. It is possible to use the hinge structure in devices comprising two or more body parts which are able to turn in relation to each other. For example, FIG. 13 illustrates a device comprising three body parts 1, 2, 2′. In this embodiment the first body part 1 is connected to the second body part 2 and the third body part 2′. The connections are advantageously produced by the foregoing hinge structures. It is also possible to use the foregoing hinge structure and some other kind of hinge structure in different connections in the same device. In addition, the hinge structure can be used in devices comprising four or more body parts.

In most of the foregoing figures the devices are illustrated without buttons, keyboards, displays, loudspeakers and microphones. As can be seen, for example, in FIG. 11, the device can comprise a necessary user interface or user interface means (for example some or all of said components). In addition, a device may comprise connectors, card slots and many other features which are not disclosed in the figures for the sake of clarity.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. A portable electronic device comprising a first housing part and a second housing part, wherein said housing parts are attached together movably by a hinge structure, said hinge structure comprising a torsion spring, which has a first end and a second end and a longitudinal axis, and the first end of the spring is connected to the first hinge half and the second end of the spring is connected to the second hinge half in such a manner that a connection point of the second end of the spring is able to rotate around the axis of the spring.

2. The electronic device according to claim 1, wherein the hinge structure has at least two positions, a first position and a second position, and the torsion spring is adjusted to reach a maximum tension when the position is changed from the first position to the second position and the tension of the spring is in a minimum in the first position and in the second position.

3. The electronic device according to claim 1, wherein the second hinge half comprises a connection point, which is a holding slot for holding the second end of the spring and the holding slot is next to the axis of rotation of the hinge structure.

4. The electronic device according to claim 1, wherein the hinge structure comprises a bush unit that is placed on the axis of rotation of the hinge structure.

5. The electronic device according to claim 1, wherein the torsion spring is a wire spring and at least a part of the longitudinal axis of the spring is placed on an axis of rotation of the hinge structure.

6. The electronic device according to claim 1, which device is one of the following: a mobile phone, a personal digital assistant, a communication device, a camera, a game device.

7. A hinge structure to be used in a portable electronic device, making it possible to turn a first housing part and a second housing part of the device in relation to an axis of rotation of the hinge structure, the hinge structure comprising at least a torsion spring, which has a first end and a second end and a longitudinal axis, and the first end of the spring is connected to a first hinge half and the second end of the spring is connected to a second hinge half in such a manner that a connection point of the second end of the spring is able to rotate around the axis of the spring.

8. The hinge structure according to claim 7, wherein the hinge structure has at least two positions, a first position and a second position, and the torsion spring is adjusted to reach a maximum tension when the position is changed from the first position to the second position and the tension of the spring is in a minimum in the first position and in the second position.

9. The hinge structure according to claim 7, wherein the second hinge half comprises a connection point, which is a holding slot for holding the second end of the spring and the holding slot is next to the axis of rotation of the hinge structure.

10. The hinge structure according to claim 7, wherein the hinge structure comprises a bush unit that is placed on the axis of rotation of the hinge structure.

11. The hinge structure according to claim 7, wherein the torsion spring is a wire spring and at least a part of the longitudinal axis of the spring is placed on the axis of rotation of the hinge structure.

12. A method for forming a foldable device, which makes it possible to rotate a first housing part and a second housing part of the device in relation to an axis of rotation of a hinge structure, in which method the first housing part is connected to the second housing part by a hinge element in such a way that the hinge element is connected by a first hinge half to the first housing part and by a second hinge half to the second housing part, the hinge halves being arranged to be movable in relation to each other by means of a pivot placed on an axis of rotation, wherein the hinge structure comprises a torsion spring, which has a first end and a second end and a longitudinal axis, and the first end of the spring is connected to the first hinge half and the second end of the spring is connected to the second hinge half in such a manner that a connection point of the second end of the spring is able to rotate around the axis of the spring.
